(19) United States
(12) Patent Application Publication
(10) Pub. No.: US 2005/0096900 A1
(43) Pub. Date: May 5, 2005

(54) Locating and confirming glottal events within human speech signals

(76) Inventors: Robert W. Bossemeyer, St. Charles, IL (US); William J. Williams, Ann Arbor, MI (US)

Correspondence Address: Law Offices of Michael Dryja, 704 228th Avenue NE PMB 694, Sammamish, WA, 98074, US

(21) Appl. No.: 10/698,629

(22) Filed: Oct. 31, 2003

(51) Int. Cl. G10L 11/04

(52) U.S. Cl. 704/219

(57) ABSTRACT

Locating and confirming glottal events within human speech signals is disclosed. In a method of one embodiment of the invention, a signal representing digitized, sampled human speech is received, and at least one speech segment is located within the signal. One or more higher energy sections within each speech segment are also located, as well as glottal events within each speech segment based on these higher energy sections. The glottal events located within each speech segment are confirmed, including registering at least some of the glottal events with adjacent glottal events. Such confirmation allows for more accurate speaker verification to be performed.

### BACKGROUND OF THE INVENTION

For a variety of security and user-authentication applications, speaker verification has become a widely used tool. Speaker verification involves a user, the speaker, uttering some predetermined speech at a place and time when the user is known to be who he or she claims to be. This speech is analyzed and stored as the reference speech of the speaker. At a later point in time, when a party wishes to verify that the user is who he or she claims to be, the user again utters the predetermined speech. This second utterance of the speech is analyzed and compared against the reference speech recorded and stored earlier. If there is a match between the two utterances, then the speaker has been successfully verified.

One approach to speaker verification focuses on the glottal events within human speech. A glottal event may generally be defined as an acoustic wave element within speech that results from the glottis, a physical part of the body within the larynx portion of the throat, modulating the flow of air when producing speech. During voiced speech, the vocal folds of the glottis open and close rapidly and repeatedly, producing pulses of air that resonate within the vocal tract of the speaker. Each response of the vocal tract to such a pulse may be referred to as a glottal event.

For glottal events to be used within speaker verification, they preferably are located and examined for consistency, such as pair-wise consistency, with other glottal events during the same utterance of speech. Locating glottal events precisely within an utterance of speech has been difficult to accomplish, however. The result with respect to speaker verification is that such verification may not be as accurate as is usually desired. For instance, users may have to re-utter speech a number of times before they are verified against previously uttered speech, which can be inconvenient and frustrating to the users.

For these and other reasons, therefore, there is a need for the present invention.

### SUMMARY OF THE INVENTION

The invention relates to locating and confirming glottal events within human speech signals. In a method of one embodiment of the invention, a signal representing digitized, sampled human speech is received, and at least one speech segment is located within the signal. One or more higher energy sections within each speech segment are also located, as well as glottal events within these higher energy sections of the speech segment. The glottal events located within each speech segment are confirmed, including registering at least some of the glottal events with adjacent glottal events.

A computer-readable medium of another embodiment of the invention includes a computer program stored thereon to perform a glottal event location and confirmation method. The method is performed for each adjacent pair of glottal events located within each speech segment within a signal representing digitized, sampled human speech. For a given pair, the first glottal event and the second glottal event of the pair are compared to determine a pair-wise distance between them. The boundaries of either the first glottal event and/or the second glottal event are adjusted to minimize the pair-wise distance between the events. This increases accuracy of subsequently performed speaker verification methods.

A speaker verification system of still another embodiment of the invention includes a computer-readable medium, a recording device, and a mechanism. The medium has stored thereon first glottal events extracted from previously recorded human speech. The recording device records further human speech, and stores a signal representing this further human speech on the medium. The mechanism generates second glottal events from this stored signal, and confirms the second glottal-events by registering each such event with adjacent events. The mechanism also compares the second glottal events, as have been confirmed, with the first glottal events to determine whether the further human speech matches the previously recorded human speech.

Embodiments of the invention provide for advantages over the prior art. The glottal event confirmation process in particular allows for better, more uniform, and more accurate analysis of the glottal events to be accomplished. This ultimately results in more accurate speaker verification occurring. Still other aspects, embodiments, and advantages of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless explicitly indicated, and implications to the contrary are otherwise not to be made.

FIG. 1 is a diagram of a system, according to an embodiment of the invention.

FIGS. 2A and 2B are flowcharts of a method, according to an embodiment of the invention.

FIG. 3 is a graph of an example sampled and digitized speech signal, according to an embodiment of the invention.

FIG. 4 is a graph of an example sampled and digitized speech signal in which endpoints of speech segments are demarcated, according to an embodiment of the invention.

FIG. 5 is a graph of the energy within an example sampled and digitized speech signal, according to an embodiment of the invention.

FIG. 6A is a graph of the amplitude of samples within an example of a sampled and digitized speech signal, according to an embodiment of the invention.

FIG. 6B is a graph of the energy within the resulting linear predictive coefficient (LPC) error signal with respect to the speech signal of FIG. 6A, according to an embodiment of the invention.

FIG. 7 is a graph of the glottal events located within a speech segment of an example sampled and digitized human speech signal, according to an embodiment of the invention.

FIGS. 8A and 8B are graphs of binomial reduced-interference distribution (RID) time-frequency distributions for two adjacent glottal events within a speech segment of an example sampled and digitized human speech signal, prior to registration of the two events, according to an embodiment of the invention.

FIG. 8C is a graph representing the difference between the binomial RID time-frequency distributions of the graphs of FIGS. 8A and 8B, according to an embodiment of the invention.

FIGS. 8D and 8E are graphs of example waveforms of the two adjacent glottal events of the graphs of FIGS. 8A and 8B, prior to registration of the two events, according to an embodiment of the invention.

FIGS. 9A and 9B are graphs of binomial RID time-frequency distributions for the two adjacent glottal events of the graphs of FIGS. 8A and 8B, but after registration of the two events to maximize their similar and minimize their pair-wise distance, according to an embodiment of the invention.

FIG. 9C is a graph representing the difference between the binomial RID time-frequency distributions of the graphs of FIGS. 9A and 9B, according to an embodiment of the invention, such that the graph of FIG. 9C depicts less difference between the distributions of the glottal events after registration than the graph of FIG. 8C depicts before registration.

FIGS. 9D and 9E are graphs of example waveforms of the two adjacent glottal events of the graphs of FIGS. 9A and 9B, after registration of the two events to maximize their similar and minimize their pair-wise distance, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

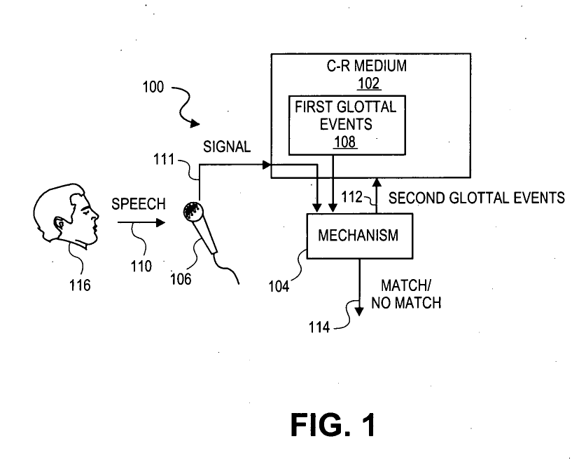

FIG. 1 shows an example rudimentary system 100, according to an embodiment of the invention. The system 100 includes a computer-readable medium 102, a mechanism 104, and a recording device 106. The computer-readable medium 102 has pre-stored thereon first glottal events 108. The first glottal events 108 are those that have been extracted from previously recorded user (human) speech, when the user is known to be who he or she claims to be. That is, the first glottal events 108 are those against which later generated second glottal events are compared, to determine if at this later point in time whether the user is who he or she claims to be. The first glottal events 108 thus serve as the reference glottal events against which glottal events subsequently extracted from subsequently recorded human speech are compared.

As has been described, a glottal event may generally be defined as an acoustic wave element within speech that results from the glottis, a physical part of the body within the larynx portion of the throat, modulating the flow of air when producing speech. During voiced speech, the vocal folds of the glottis open and close rapidly and repeatedly, producing pulses of air that resonate within the vocal tract of the speaker. Each response of the vocal tract to such a pulse may be referred to as a glottal event.

The mechanism 104 may be a computer program stored on the computer-readable medium 102 and running on a computer. Alternatively, the mechanism 104 may be special-purpose hardware and/or software. That is, the mechanism 104 may be or include software, hardware, or a combination of software and hardware, as can be appreciated by those of ordinary skill within the art. The computer-readable medium 102 may be or include magnetic media, such as hard disk drives or floppy disks, optical media, such as CD- and DVD-type optical discs, and/or semiconductor media, such as flash memory and dynamic random-access memory. The medium 102 may further be a non-volatile or a volatile medium.

The recording device 106 may be a microphone, or another type of device that is capable of receiving or detecting human speech 110 and generating a signal 111 in response thereto that represents the human speech 110. Thus, a user 116 utters the human speech 110, which is recorded by the recording device 106 as the signal 111 and stored on the computer-readable medium 102. The mechanism 104 in turn digitizes the signal 111 by sampling the signal 111. The mechanism 104 extracts, or generates, second glottal events 112 from the signal 111 as has been recorded and digitized. The mechanism 104, in the process of generating the second glottal events 112, confirms or registers each such event with adjacent glottal events, as is described in more detail later in the detailed description. The second glottal events 112 may also be stored on the medium 102.

The mechanism 104 finally compares the second glottal events 112 with the first glottal events 108. In response, the mechanism 104 indicates whether the second glottal events 112 match the first glottal events 108, as indicated by the arrow 114. For instance, if the second glottal events 112 match the first glottal events 108, then the user 116 uttering the speech 110 has been verified as the user who had earlier uttered the speech from which the first glottal events 108 were extracted. Comparison and matching of the second glottal events 112 with the first glottal events 108 can be accomplished by existing approaches to speaker verification, such as Hidden Markov Models, Gaussian Mixture Models, as well as other types of models. It is noted that the mechanism 104 having previously confirmed each of the second glottal events 112 with their adjacent events increases the accuracy of the comparison and matching process.

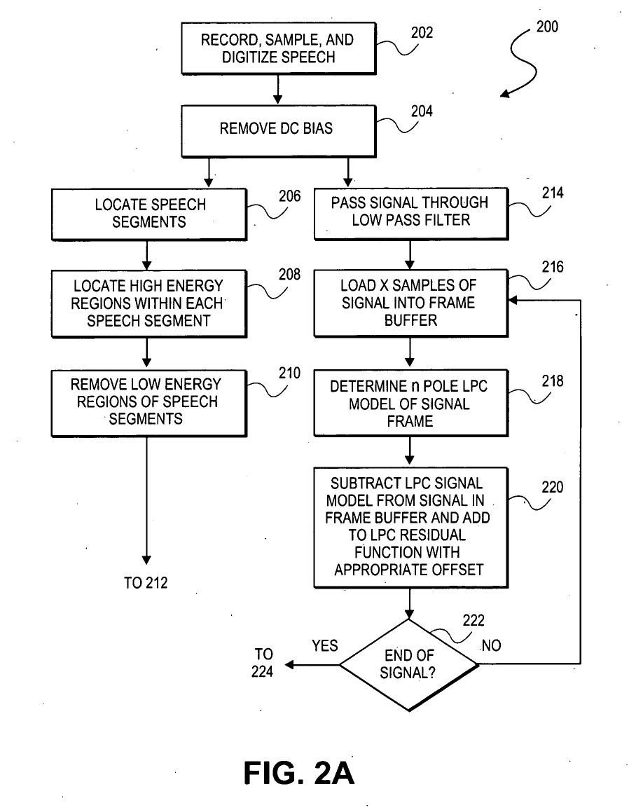

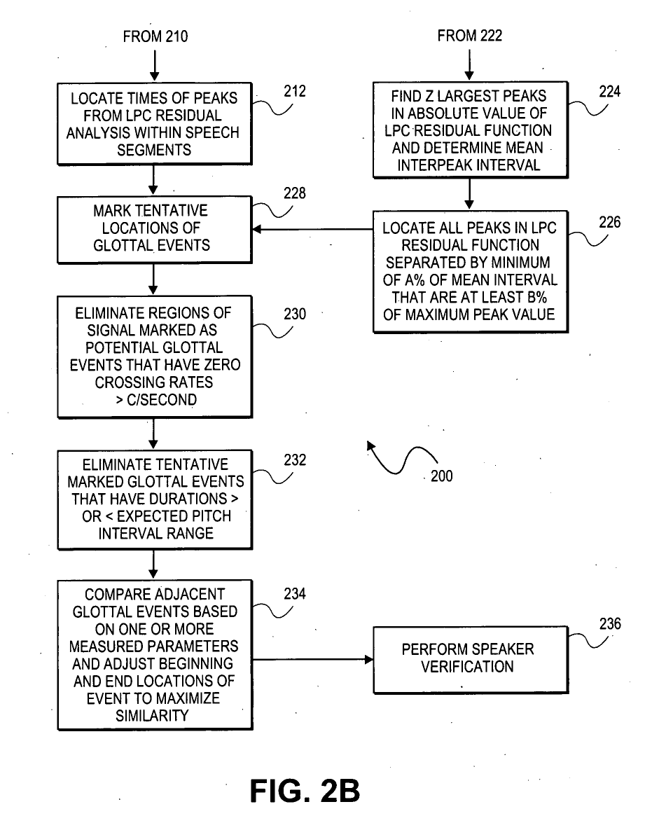

FIGS. 2A and 2B show a method 200, according to an embodiment of the invention. The method 200 is divided into the two FIGS. 2A and 2B for illustrative clarity. The method 200 may be implemented as a computer program stored on a computer-readable medium, such as the medium 102 of FIG. 1. Furthermore, the method 200 may be performed by components of the system 100 of FIG. 1, such as the mechanism 104 and/or the recording device 106.

First, speech 110 is uttered by the user, or speaker, 116, which is recorded by the recording device 106 as the signal 100, and sampled and digitized by the mechanism 104 (202). The speech 110 may be recorded by more than one recording device as well. For instance, the speech 110 may be recorded simultaneously by both a high-fidelity studio microphone, as well as a telephone handset. The sample rate and bit resolution of the sampling process, to digitize the signal 100 that represents the speech 110, depend on the type of channel over which the speech 110 is recorded. For example, speech that has been transmitted over a telephone network is stored in an eight-bit mu-law format at an eight-kilohertz (kHz) sample rate, since that is the native format for such networks. Therefore, little is gained by digitizing the speech 110 at higher sample rates or by using more bits per sample. However, where the speech 110 is recorded through a high-fidelity microphone, sampling may be accomplished with sixteen-bit resolution at a standard speech sample rate of sixteen kHz to preserve frequencies within the speech 110.

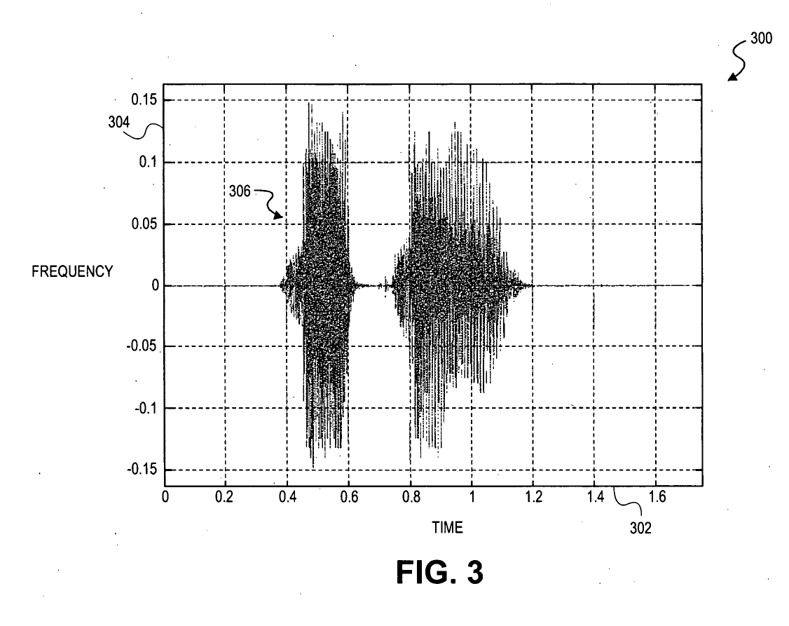

FIG. 3 shows an example graph 300 of a sampled and digitized speech signal, according to an embodiment of the invention. The y-axis 304 displays sample values, typically normalized to a maximum AID converter range of ±1, as a function of time in seconds on the x-axis 302. The signal 306 represents sampled and digitized speech.

Referring back to FIGS. 2A and 2B, any direct current (DC) bias present within the sampled and digitized speech signal is removed (204). The DC bias represents a zero-frequency component that may be undesirably inserted within the signal as a result of the recording process and/or the sampling and digitization process. The method 200 then performs two concurrent tracks of steps and/or acts—the track beginning at 206, and the track beginning at 214. For ease of description, the first track, beginning at 206, is first completely described, before the second track, beginning at 214, is described.

The sample and digitized speech signal is thus examined to locate the speech segments within the signal (204). A speech segment can be generally defined as a discrete segment within the speech signal, such that there is a pause in amplitude variation within the speech signal between successive segments. Locating the speech segments is accomplished by determining the energy in the signal, and examining this energy for regions that are above a given threshold. The threshold for detecting speech is based on a background noise estimation, determined from the first few milliseconds of the sampled signal, and updated throughout the recording interval to adjust for changes in the noise. A signal-to-noise average value for the recorded signal is determined, and used as a baseline to determine the quality of recording. A low signal-to-noise ratio may indicate that the speaker did not utter his or her speech directly into the microphone, and may need to provide another speech utterance. A signal-to-noise ratio of at least twenty decibels (dB) can in one embodiment be considered needed for determining accurate endpoints and determining reliable features from the speech.

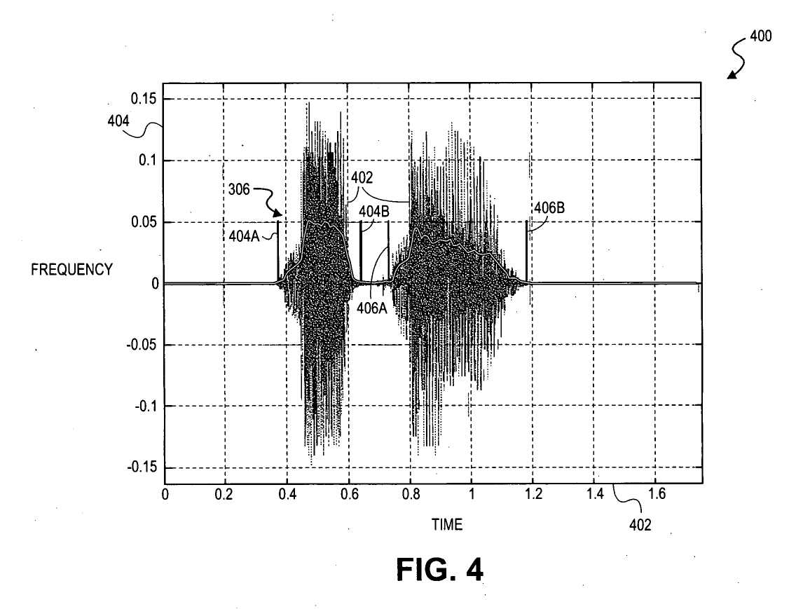

FIG. 4 shows an example graph 400 of a sampled and digitized speech signal in which endpoints of speech segments are demarcated, according to an embodiment of the invention. The y-axis 304 again denotes sample amplitude values as a function of time on the x-axis 302. The signal 306 is the same as the signal 306 in FIG. 3. The amplitude of the signal 306 at a given point in time is represented by the lines 402. The endpoints 404A and 406A represent the beginning point and end point of a first speech segment, whereas the endpoints 404B and 406B representing the beginning point and end point of a second speech segment.

Referring back to FIGS. 2A and 2B, high energy regions are then located within each speech segment (208). In one embodiment, the high energy regions within each segment may by those in which the energy is at least twenty percent of the peak energy in that segment. Another value, other than twenty percent of the peak energy, may also be used. Furthermore, a high energy region may be defined in a way other than as a percentage of the peak energy within a speech segment. Once the high energy regions within the speech segments have been identified, the remaining low energy regions of the speech segments are eliminated from the segments (210). Therefore, what remains in the speech segments are the high energy regions thereof.

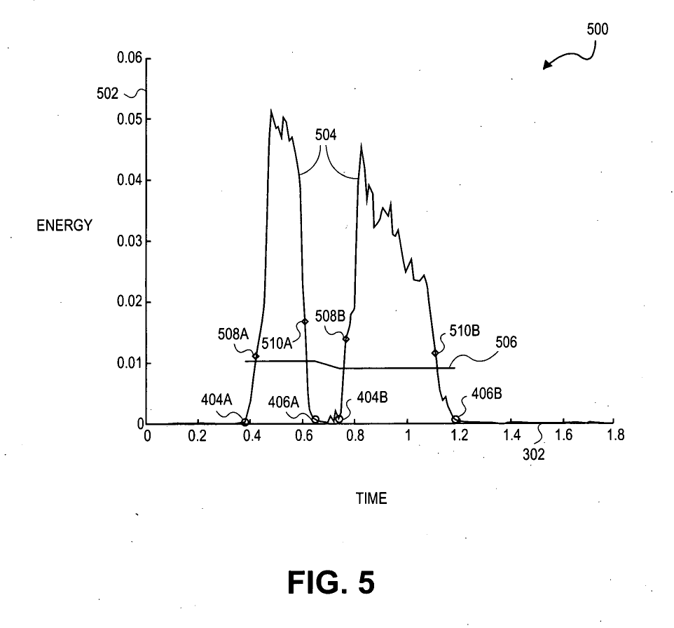

FIG. 5 shows an example graph 500 of the energy within a sampled and digitized speech signal, according to an embodiment of the invention. The y-axis 502 denotes energy or power, as a function of time on the x-axis 302. The signal 504 represents the energy within the signal 306 of FIGS. 3 and 4. The endpoints 404A and 406A denote the first speech segment, whereas the endpoints 404B and 406B denote the second speech segment. The line 506 indicates the threshold percentage of peak energy within each speech segment, in this case, twenty percent of the peak energy within each speech segment. As a result, the endpoints 508A and 510A represent the beginning point and end point of the high energy region within the first speech segment, and the endpoints 508B and 510B represent the beginning point and end point of the high energy region within the second speech segment.

Referring back to FIGS. 2A and 2B, the speech segments within the signal, having just their high energy regions, are subjected to a linear predictive coefficient (LPC) (residual) analysis, as can be appreciated by those of ordinary skill within the art, and the times at which the peaks occur within the speech segments are determined therefrom (212). This is accomplished to demarcate glottal events. Therefore, first, the high energy regions of the speech segments are subjected to an LPC analysis. The LPC residual error signal, determined as the square of the difference between the actual signal and the LPC-derived model of the signal, is used to identify the beginning of each glottal event. The LPC residual error has local maxima at locations where the LPC model of the signal does not conform to the signal. Such maxima naturally occur at the points where glottal pulses occur during voice speech.

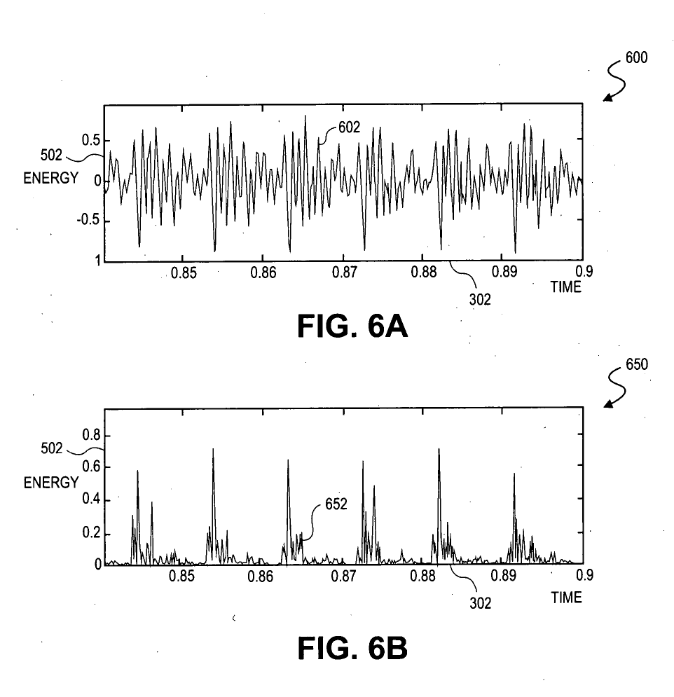

FIG. 6A shows an example graph 600 of the sample amplitudes within a sampled and digitized speech signal and FIG. 6B an example graph 650 showing the energy within the resulting LPC residual error signal, according to an embodiment of the invention. The y-axis 502 denotes sample amplitude as a function of time on the x-axis 302. The signal 602 of FIG. 6A is the sequence of sample amplitudes within the sampled and digitized speech signal, and the signal 652 of FIG. 6B is the energy within the resulting LPC residual error signal. The signal 602 represents a number of glottal events. Each repeating pattern is specifically a glottal event, or a response to a pulse of air that dampens out until the next pulse occurs. The signal 652 thus registers a large spike near the beginning of each such event.

Demarcation of the glottal events continues, after subjecting the high energy regions of the speech segments to an LPC analysis, by first locating the largest n peaks, where n may in one embodiment be twenty, separated by a minimum time corresponding to a reasonable glottal event interval, and determining the mean interval value between adjacent such events. Next, all the peaks with a minimum separation, defined to be a percentage of the estimated average glottal event interval, between adjacent peaks are located. Enforcing a minimum separation, which in one embodiment of the invention is 80% of an estimated interval, thus precludes secondary peaks within the LPC residual error signal from being selected as glottal event locations.

Referring back to FIGS. 2A and 2B, the second concurrent track starts by passing the sampled and digitized human speech signal through a low-pass filter (214). The second concurrent track is also for the demarcation of glottal event locations, but in a different way than in the first concurrent track. Passing the signal through a low-pass filter removes extraneous high frequency elements of the signal that are not needed, and that may have been inadvertently added into the signal as noise during the recording, sampling and/or digitizing processes. A number of samples of the signal are loaded into a frame buffer (216), such as the number of samples equal to a twenty millisecond long frame, at one time. An n-pole LPC model is then determined for a given signal frame (218). The n-pole LPC model may in one embodiment be a thirty-pole LPC model, as can be appreciated by those of ordinary skill within the art. The LPC model is constructed by performing an LPC analysis on the signal sample within the frame buffer, as has been described.

Next, the LPC signal model is subtracted from the signal in the frame buffer, and this difference signal accumulates as a LPC residual function by adding this segment of the signal to the previous difference signals, with an appropriate offset (220). The appropriate offset is added to ensure that the LPC residual function aligns with the LPC signal as subtracted from the signal in the frame buffer, as can be appreciated by those of ordinary skill within the art. The end result of this subtraction and addition is the LPC residual error signal as has been described in conjunction with 212, and an example of which is depicted in FIG. 6B as the signal 652 of the graph 650. If further samples of the signal exist, then the method 200 proceeds from 222 back to 216, and 216, 218, and 220 are performed again with another number of samples of the signal, until no more samples of the signal are present. In this case, the method 200 proceeds from 222 to 224.

The Z largest peaks within the absolute value of the LPC residual function are then located, and the mean inter-peak interval with respect to this function determined (224). For instance, Z may be twenty, such that the largest twenty peaks are determined, as in 212. Thereafter, all the peaks within the LPC function, separated by a minimum of A percent of the mean interval that are at least B percent of the maximum peak value, are located, and correspond to the glottal events as found within the approach of the second concurrent track (226). In one embodiment, A may be eighty, whereas B may be forty. The method 200 then is finished with the second concurrent track beginning at 214, such that it proceeds to 228, where the method 200 also proceeds to after finishing with the first concurrent track beginning at 206. The resulting glottal events that were demarcated in 212 and 226 are thus marked as tentative locations of glottal events (228).

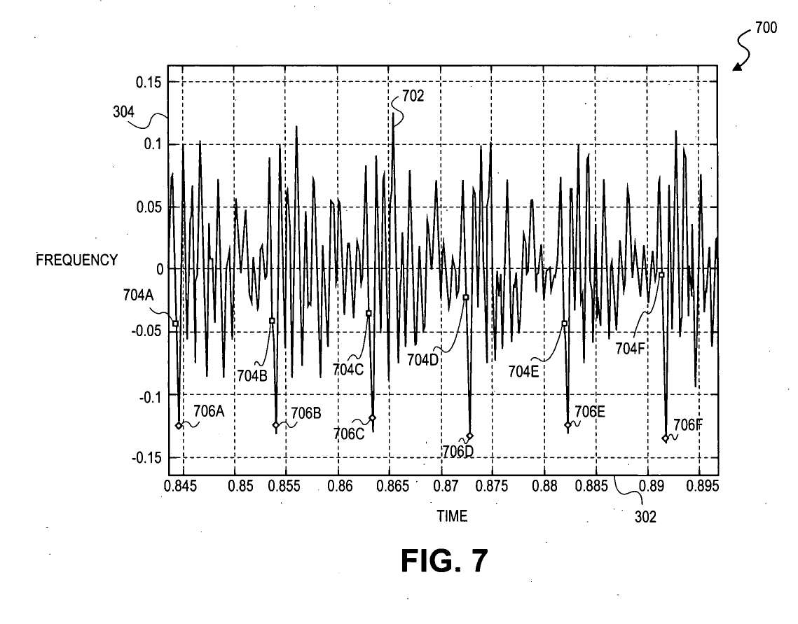

FIG. 7 shows an example graph 700 of the glottal events located within a speech segment of a sampled and digitized human speech signal, in accordance with the two concurrent tracks of the method 200 that have been described, according to an embodiment of the invention. The y-axis 304 denotes sample amplitude as a function of time on the x-axis 302. The speech segment signal 702 has demarcated thereon points 704A, 704B, 704C, 704D, 704E, and 704F, which correspond to the beginning of glottal events determined by the method 200 of FIG. 2. The speech segment signal 702 also has demarcated thereon points 706A, 706B, 706C, 706D, 706E, and 706F, which correspond to the beginning of glottal events determined by a different approach. The beginning point of a given glottal event may also be considered the end point of the previous, adjacent glottal event, in one embodiment of the invention, such that the end point of the last glottal event may be considered the end of the speech segment in which the last glottal event occurs.

Referring back to FIGS. 2A and 2B, regions with the speech segments of the sampled and digitized speech signal that have been marked as potential glottal events, but that have a zero crossing rate greater than C per second, are removed from the pool of glottal events (230). The zero crossing rate of a glottal event is generally defined as the number of times per second that the amplitude sample sequence proceeds from positive values to negative values and visa versa, where the rate C per second may in one embodiment be-4500. Next, tentatively marked glottal events that have durations outside the expected pitch interval range are also removed from the pool of glottal events (232). The expected pitch interval range is the pitch interval range within which human speech is expected to lie. Thus, durations outside of this range are likely not human speech, and therefore are removed. The pitch interval range in one embodiment of the invention may be 40 Hz to 500 Hz. The result of performing 230 and 232 is that there is a set of glottal events.

Next, the glottal events that have been determined are confirmed by a registration process. In particular, adjacent glottal events are compared, based on one or more measured parameters, and their beginning and end points, or locations, are adjusted to maximize similarity between adjacent events (234). Such confirmation or registration is accomplished because the precise locations of the glottal events may be important to the success of subsequently performed speaker verification processes. That is, performing 234 verifies that the location of each glottal event as suggested by the different detection approaches is confirmed with an independent approach, enabling the boundaries on each event to come into registration with the events advance thereto. The boundaries, such as the beginning and end points, of each glottal event are allowed to shift a few sample points in either direction to minimize a pair-wise distance, or another measured parameter, between adjacent events, maximizing their similarity. The pair-wise distance between adjacent glottal events is generally defined as the absolute value or square of the difference between samples of the parameters of the two glottal events, summed over the duration of the shorter of the two events and divided by the number of samples in the difference. Minimizing the pair-wise distance between adjacent events eliminates poorly isolated glottal events from further consideration, since all glottal events are verified to be similar to their immediately adjacent neighbor glottal events.

Thus, in on embodiment of the invention, in 234 of the method 200 of FIG. 2, for each adjacent pair of glottal events, the two glottal events of the pair are compared to determine a pair-wise distance between them. The boundaries of either the first glottal event and/or the second glottal event are then adjusted, to minimize the pair-wise distance between them. The boundaries may be adjusted in an iterative approach in one embodiment, such that either or both boundaries of the first glottal event are first adjusted by ±one point, ±two points, and so on, and the effect of such adjustments on the pair-wise distance between the events is noted, and such that then either or both boundaries of the second glottal event are adjusted by ±one point, ±two points, and so on and the effect of such adjustments on the pair-wise distance is noted. That is, either the start point and/or the end point of either the first glottal event of the pair and/or the second glottal event of the pair may be adjusted by one or more points in either the positive or negative direction. Whichever adjustment or adjustments yields the largest minimization of the pair-wise distance between the adjacent glottal events is then retained. Approaches other than such an iterative approach may also be employed to minimize pair-wise distance, and thus maximize similarity, between the two glottal events of an adjacent pair of such events.

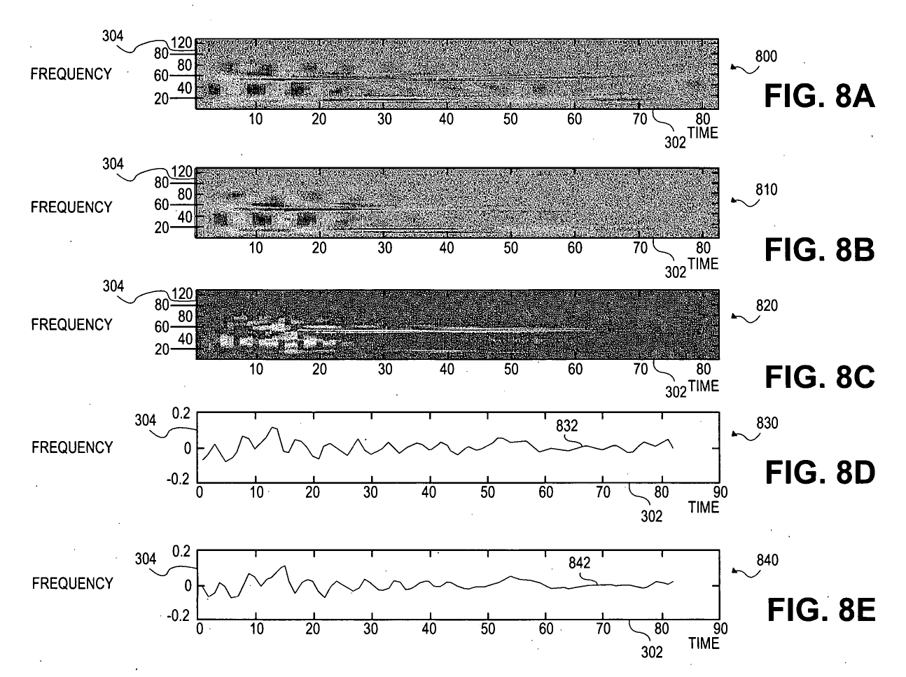

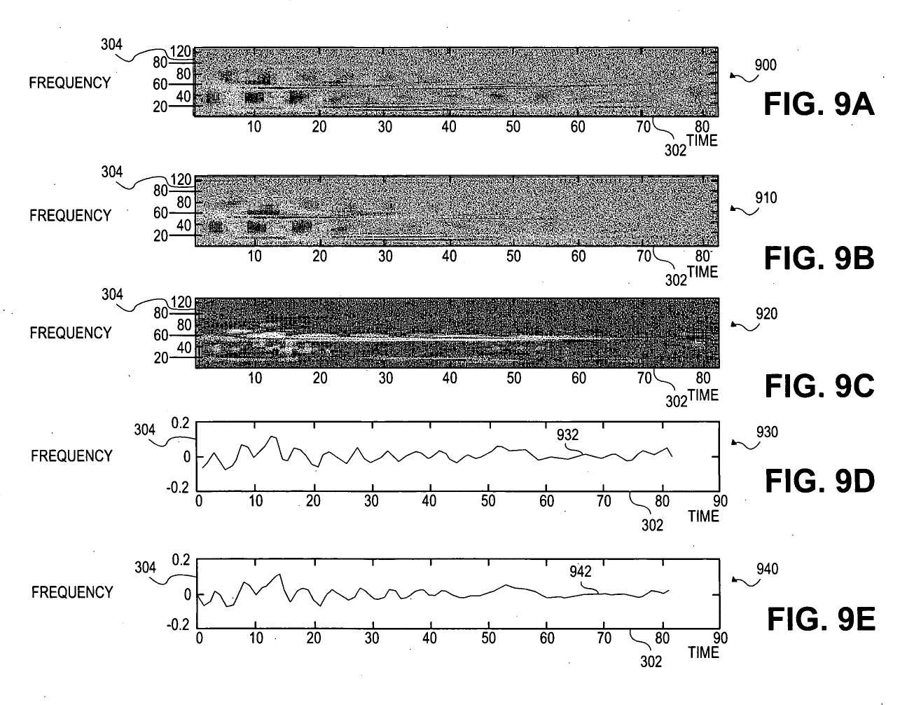

An example of the approach performed in 234 of the method 200 of FIG. 2 is described in relation to FIGS. 8A, 8B, 8C, 8D, and 8E, and FIGS. 9A, 9B, 9C, 9D, and 9E. FIGS. 8A and 8B show example graphs 800 and 810 of binomial reduced-interference distribution (RID) time-frequency distributions for two adjacent glottal events within a speech segment, according to an embodiment of the invention. FIG. 8C shows an example graph 820 that represents the difference between the binomial RID time-frequency distributions of the graphs 800 and 810, according to an embodiment of the invention. FIGS. 8D and 8E show example graphs 830 and 840 of the waveforms for the two adjacent glottal events represented in the graph 800 and 810 of FIGS. 8A and 8B, respectively, according to an embodiment of the invention, where the signal 832 is of one of the glottal events, and the signal 842 is the other glottal event. In each of the graphs 800, 810, and 820, frequency is denoted on the y-axis 304 as a function of time on the x-axis 302. In each of the graphs 830 and 840, sample amplitude is denoted on the y-axis as a function of time on the x-axis. It is noted that although the distributions of the graphs 800 and 810 are quite similar, as are the signals 832 and 842 of the graphs 830 and 840, there is still a significant difference in value between the two glottal events, as shown in the graph 820.

By comparison, FIGS. 9A and 9B show example graphs 900 and 910 of binomial RID time-frequency distributions for the two adjacent glottal events of the graphs 800 and 810, where the boundaries of the events have been allowed to adjust so that the events are better aligned with one another, according to an embodiment of the invention. FIG. 9C shows an example graph 920 that represents the difference between the binomial RID time-frequency distributions of the graphs 900 and 910, according to an embodiment of the invention. FIGS. 9D and 9E show example graphs 930 and 940 of the waveforms for the two adjacent glottal events represented in the graphs 900 and 910 of FIGS. 9A and 9B, respectively, according to an embodiment of the invention, where the signal 932 is one of the glottal events, and the signal 942 is the other glottal event. In each of the graphs 900, 910, and 920, frequency is denoted on the y-axis 304 as a function of time on the x-axis 302. In the graphs 930 and 940, sample amplitude is denoted on the y-axis as a function of time on the x-axis. The difference plot of the graph 920 in particular shows that there is less of a difference between the two distributions of the graphs 900 and 910, as compared to the difference plot of the graph 820. Inspection of the graphs 930 and 940 also shows that the two events are in better alignment.

Referring finally back to FIGS. 2A and 2B, once the glottal events have been located and confirmed, or registered, speaker verification can then be performed (236), as has been described. The registration process of the glottal events in 234, which can be generally defined as adjusting the boundaries of the glottal events such that adjacent glottal events are maximized in similarity, or minimized in pair-wise distance, allows for the speaker verification to generally be more accurate. This is because locating and maintaining glottal events that are consistent eases the various computations, comparisons, and determinations that may be performed in the speaker verification process, allowing the process to ultimately be more accurate, and requiring less retries by the speaker than if registration, confirmation, or verification were not performed.

It is noted that, although specific embodiments have been illustrated and described herein, it will be appreciated by those of ordinary skill in the art that any arrangement that is calculated to achieve the same purpose may be substituted for the specific embodiments shown. Other applications and uses of embodiments of the invention, besides those described herein, are amenable to at least some embodiments. This application is intended to cover any adaptations or variations of the present invention. Therefore, it is manifestly intended that this invention be limited only by the claims and equivalents thereof.

1. A method comprising:
receiving a signal representing digitized, sampled human speech;
locating at least one speech segment within the signal;
locating one or more higher energy sections within each speech segment within the signal;
locating a plurality of glottal events within each speech segment within the signal, based on the one or more higher energy sections within each speech segment; and,
confirming the plurality of glottal events located within each speech segment within the signal, including registering each of at least one of the plurality of glottal events with adjacent glottal events.

2. The method of claim 1, wherein receiving the signal representing the digitized, sampled human speech comprises:
recording human speech; and,
sampling the human speech to digitize the human speech, yielding the signal.

3. The method of claim 1, wherein locating at least one speech segment within the signal comprises determining a start point and an end point of each speech segment.

4. The method of claim 1, wherein locating at least one speech segment within the signal comprises determining an energy within the signal and examining the energy for regions above a threshold, such that each region above of the threshold corresponds to a speech segment.

5. The method of claim 1, wherein locating the one or more higher energy sections within each speech segment comprises determining regions within each speech segment where an energy is at least a percentage of a peak energy within the speech segment.

6. The method of claim 1, wherein locating the plurality of glottal events within each speech segment comprises, for each speech segment:
subjecting each higher energy section within the speech segment to a linear predictive coefficient (LPC) analysis, yielding a LPC residual error signal for each higher energy section;
locating a number of largest peaks within the LPC residual error signal for each higher energy section that have a minimum separation between adjacent of the peaks; and,
locating the plurality of glottal events within the speech segment as corresponding to the number of largest peaks within the LPC residual error signal that have the minimum separation.

7. The method of claim 6, wherein subjecting each higher energy section to LPC analysis, yielding the LPC residual error signal, comprises, for each higher energy section, determining the LPC residual error signal as the square of the difference between the higher energy section and an LPC-derived model of the higher energy section.

8. The method of claim 6, wherein locating the number of largest peaks within the LPC residual error signal that have the minimum separation between adjacent of the peaks comprises, from all the largest peaks within the LPC residual error signal, removing those peaks that lack the minimum separation between adjacent of the peaks.

9. The method of claim 1, wherein confirming the plurality of glottal events located within each speech segment comprises, for each adjacent pair of glottal events within each speech segment:
comparing a first glottal event and a second glottal event of the adjacent pair of glottal events to determine a pair-wise distance between the first and the second glottal events; and,
adjusting boundaries of at least one of the first glottal event and the second glottal event to minimize the pair-wise distance between the first and the second glottal events, maximizing similarity of the first and the second glottal events of the adjacent pair.

10. A computer-readable medium having a computer program stored thereon to perform a glottal event confirmation method comprising:
for each adjacent pair of glottal events within each of a plurality of speech segments within a signal representing digitized, sampled human speech,
comparing a first glottal event and a second glottal event of the adjacent pair of glottal events to determine a pair-wise distance between the first and the second glottal events; and,
adjusting boundaries of at least one of the first glottal event and the second glottal event to minimize the pair-wise distance between the first and the second glottal events,
such that the glottal event confirmation method increases accuracy of subsequently performed speaker verification methods.

11. The medium of claim 10, wherein adjusting the boundaries of at least one of the first glottal event and the second glottal event comprises adjusting at least one of a start point and an end point of at least one of the first glottal event and the second glottal event.

12. The medium of claim 10, wherein adjusting the boundaries of at least one of the first glottal event and the second glottal event maximizes similarity of the first and the second glottal events.

13. The medium of claim 10, wherein the method further comprises initially locating a plurality of glottal events within each speech segment within the signal.

14. The medium of claim 13, wherein locating the plurality of glottal events within each speech segment comprises, for each speech segment:
subjecting each of a plurality of higher energy sections within the speech segment to a linear predictive coefficient (LPC) analysis, yielding a LPC residual error signal for each higher energy section;
locating a number of largest peaks within the LPC residual error signal for each higher energy section that have a minimum separation between adjacent of the peaks;
locating the plurality of glottal events within the speech segment as corresponding to the number of largest peaks within the LPC residual error signal that have the minimum separation;
removing any of the plurality of glottal events within the speech segment that have a zero crossing rate greater than a threshold rate; and,
removing any of the plurality of glottal events within the speech segment that have a duration outside of a threshold pitch interval range.

15. The medium of claim 13, wherein the method further comprises, prior to locating the plurality of glottal events within each speech segment:
locating the plurality of speech segments within the signal; and,
locating one or more higher energy sections within each speech segment.

16. The medium of claim 15, wherein the method further comprises, prior to locating the plurality of speech segments within the signal, receiving the signal.

17. A speaker verification system comprising:
a computer-readable medium having stored thereon a plurality of first glottal events extracted from previously recorded human speech; and,
a recording device to record further human speech and store a signal representing the further human speech on the computer-readable medium; and,
a mechanism to generate a plurality of second glottal events from the signal, to confirm the plurality of second glottal events by registering each second glottal event with adjacent second glottal events, and to compare the plurality of second glottal events with the plurality of first glottal events to determine whether the further human speech recorded matches the previously recorded human speech.

18. The speaker verification system of claim 17, wherein accuracy of determining whether the further human speech recorded matches the previously recorded human speech is increased by the mechanism confirming the plurality of second glottal events by registering each second glottal event with adjacent second glottal events.

19. The speaker verification system of claim 17, wherein-the mechanism is a computer program stored on the computer-readable medium.

20. A speaker verification system comprising:
means for recording human speech and for storing a signal representing the human speech on a computer-readable medium having previously stored thereon a plurality of first glottal events extracted from previously recorded human speech; and,
means for generating a plurality of second glottal events from the signal, for confirming the plurality of second glottal events by registering each second glottal event with adjacent second glottal events, and for comparing the plurality of second glottal events with the plurality of first glottal events to determine whether the further human speech recorded matches the previously recorded human speech.
